(19) United States
(12) Patent Application Publication
(10) Pub. No.: US 2011/0087552 A1
(43) Pub. Date: Apr. 14, 2011

(54) METHOD AND APPARATUS FOR MODIFYING AUDIO OR VIDEO FILES

(76) Inventors: Lorenzo Carver, Boulder, CO (US); Mark Freedle, Walla Walla, WA (US)

(21) Appl. No.: 12/901,827

(22) Filed: Oct. 11, 2010

Related U.S. Application Data
(60) Provisional application No. 61/250,436, filed on Oct. 9, 2009.

(51) Int. Cl. G06Q 30/00

(52) U.S. Cl. 705/14.72

(57) ABSTRACT

Methods and apparatus for alerting a user to an opportunity are provided. The method includes delivering an audio signal to an audio output device, modifying at least a portion of the audio signal, outputting the modified audio signal, and displaying an opportunity on the display screen at substantially the same time that the modified portion of the audio signal is output.

### CROSS REFERENCE TO RELATED APPLICATION

The present application claims the benefit of priority of U.S. Provisional Application No. 61/250,436, filed Oct. 9, 2009, which is herein incorporated by reference in its entirety.

### FIELD

The present disclosure is directed to methods and apparatuses for modifying audio or video files to alert a user of an offer or opportunity, and using geographic location tools to connect individuals and businesses.

### BACKGROUND

In modern society, electronic devices used by individuals are inundated by information delivered from numerous media sources. This information includes, for example, audio and video files delivered to computers, televisions, radios, cellphones, and other personal electronics and/or computer-based devices. Because of the sheer amount of information that is delivered into the electronic devices, it can be difficult to deliver information to users of these devices in a manner in which the user recognizes and/or distinguishes the information from other information that is being simultaneously or sequentially delivered to the device. Also, it can be difficult to deliver this information to the device in a manner that limits or reduces interruptions and/or distractions to the user.

Accordingly, it is desirable to provide a system and method for the delivery of information to an electronic device in a manner that renders the information easily recognizable and/or distinguishable by the user. Also, it is desirable to provide a system and method wherein the delivery of such information is less intrusive to other information that is being concurrently delivered to the device.

### SUMMARY

In one embodiment, a method of alerting a user to an opportunity is provided. The method comprises providing an audio output device with a display screen; delivering an audio signal to the audio output device; modifying at least a portion of the audio signal; outputting the modified audio signal on the audio output device, the output of the audio signal being a plurality of sounds audible to the user; and displaying the opportunity on the display screen at substantially the same time that the modified portion of the audio signal is output on the audio output device. The modified portion of the audio signal is altered from the original by an amount sufficient to alert the user to the promotional opportunity.

In specific implementations, the audio signal is modified prior to delivery to the audio output device. In other specific implementations, the audio signal is modified after delivery to the audio output device. The act of modifying the audio signal can comprise inserting one or more tones into the audio signal. The inserted one or more tones can comprise a sound preselected by the user.

In other specific implementations, the act of modifying the audio signal can comprise repeating the portion of the audio signal so that the user hears the same plurality of sounds repeated two or more times. The opportunity can comprise a request for the user to perform an action. The action that is requested to be performed by the user can be the completion of a survey. Alternatively, the action that is requested to be performed by the user can be the downloading of a file. Alternatively, the action that is requested to be performed by the user is the opening up an URL or media file/asset.

In another embodiment, another method of alerting a user to an opportunity can be provided. The method can comprise providing an video output device with a display screen; delivering a video signal to the video output device; modifying at least a portion of the video signal; outputting the modified video signal on the video output device, the output of the video signal including a plurality of images visible to the user; and displaying the opportunity on the display screen at substantially the same time that the modified portion of the video signal is output on the video output device. The modified portion of the video signal can be altered from the original by an amount sufficient to alert the user to the promotional opportunity. In other specific implementations, the modification to the video signal comprises modifying an audio component of the video signal.

In another embodiment, a method of rhythmically varying an audio file is provided. The method comprises providing an audio output device with a display screen; delivering an audio signal to the audio output device; modifying at least a portion of the audio signal so that upon playback, the modified portion comprises a rhythmic portion; outputting the rhythmic portion, the rhythmic portion comprising a plurality of sounds audible to the user; and displaying an opportunity on the display screen at substantially the same time that the rhythmic portion of the audio signal is output on the audio output device.

In specific implementations, the rhythmic portion is sufficiently different from adjacent portions of the audio file during playback to gain the attention of the user. In other specific implementations, the audio signal is modified prior to delivery to the audio output device. In other specific implementations, the audio signal is modified after delivery to the audio output device. The audio signal can be part of a video signal, which is also modified during the method so that the video portion of the signal is in synch with the audio portion.

The foregoing and other objects, features, and advantages of the disclosed embodiments will become more apparent from the following detailed description, which proceeds with reference to the accompanying figures.

### BRIEF DESCRIPTION OF THE DRAWINGS

FIG. 1 represents an audio signal of a portion of an audio file.

FIG. 2 represents a second audio signal, in which a portion of the audio file has been modified.

FIG. 3 is a flow chart illustrating a method of delivering an opportunity to a user.

FIG. 4 is a schematic illustration of a computer.

FIG. 5 is a block diagram of a computer system.

FIG. 6 is a flow chart of a conventional method and apparatus for processing a physical electronic payment transaction for a single retailer.

FIG. 7 illustrates an exemplary POS transaction entry terminal that may be used to execute the software of an embodiment disclosed herein.

FIG. 8 is a block diagram of the exemplary POS transaction entry terminal system shown in FIG. 4.

FIG. 9a is a flow chart of a system architecture in accordance with one embodiment of the present disclosure.

FIG. 9b is a flow chart illustrating using the processing a credit card transaction to populate a database with a consumer's location and trigger socialization and dating possibilities in accordance with one embodiment of the present disclosure.

FIG. 10 is a flow chart illustrating another embodiment involving a socialization or dating type website.

FIG. 11 is a flow chart of a process flow for enrolling consumers and their cards for association with location based socialization sites in accordance with an embodiment of the present disclosure.

FIG. 12 is a schematic of an embodiment in which a portion of an audio file is rhythmically modified or altered.

### DETAILED DESCRIPTION

The following description is exemplary in nature and is not intended to limit the scope, applicability, or configuration of the disclosures in any way. Various changes to the described embodiment may be made in the function and arrangement of the elements described herein without departing from the scope of the invention.

As used in this application and in the claims, the singular forms “a,” “an,” and “the” include the plural forms unless the context clearly dictates otherwise. Additionally, the term “includes” means “comprises.” Further, the term “associated” generally mean electrically, electromagnetically, logically, and/or physically (e.g., mechanically or chemically) coupled or linked and does not exclude the presence of intermediate elements between the coupled or associated items absent specific contrary language.

Although the operations of exemplary embodiments of the disclosed method may be described in a particular, sequential order for convenient presentation, it should be understood that disclosed embodiments can encompass an order of operations other than the particular, sequential order disclosed. For example, operations described sequentially may in some cases be rearranged or performed concurrently. Further, descriptions and disclosures provided in association with one particular embodiment are not limited to that embodiment, and may be applied to any embodiment disclosed.

Moreover, for the sake of simplicity, the attached figures may not show the various ways (readily discernable, based on this disclosure, by one of ordinary skill in the art) in which the disclosed system, method, and apparatus can be used in combination with other systems, methods, and apparatuses. Additionally, the description sometimes uses terms such as “produce” and “provide” to describe the disclosed method. These terms are high-level abstractions of the actual operations that can be performed. The actual operations that correspond to these terms can vary depending on the particular implementation and are, based on this disclosure, readily discernible by one of ordinary skill in the art.

Modification or Alteration of Media

The present disclosure relates to technology for delivering information to users that stream audio and/or video media, or who otherwise engage in using electronic and/or computer-based devices to receive audio or video media. The embodiments disclosed here provide methods of delivering effects and/or sounds to the user to make the user aware of certain information (e.g., a promotional opportunity) that they may have an interest in. Preferably, the effects and/or sounds are brief in duration, so that the effects and/or sounds do not significantly detract from or interrupt a listening or viewing experience of the user.

In some embodiments, after the user is made aware of the information, the user can be provided with an opportunity to take one or more actions. For example, the user can be provided with additional visual, textual, audio, or video information, which is displayed on the screen of the device or otherwise conveyed through the device (e.g., by audio). The additional information can describe or provide details about an opportunity, such as a promotional opportunity, that is available to the user.

The method of communication or expression described herein may be embedded, combined, or interleaved inside existing communications including, but not limited to audio and video streams on a communication network, video games, and textual data. The system has the ability to connect and interoperate with existing systems as follows: (1) by passive or active insertion using a software, hardware, network, or radio proxy operating at either the business, client, or transport stage; (2) by manual control before, during, or after media production; (3) by automatic, bulk, or batch process before, during, or after media product; (4) by passive or active insertion via a content delivery network (CDN); (5) by passive or active insertion via satellite.

Furthermore, the systems disclosed herein can insert audio, video, textural information, and/or any combination of audio, video, and textual information into any channel, carrier signal, field, schema, object, or encapsulation that is present within the media.

The system has the capability to modify the original media so that various effects are added as a result of the messaging combination. These effects include, but are not limited to mono, stereo, surround sound, quadraphonic, DTS, and THX recalibration, spatial sound effects such as echoes, visual effects such as watermarks, and volume regulation.

Audio Playback Manipulation

In a first embodiment, a system for manipulating the audio playback of an existing audio file is provided. The playback device, such as a streaming audio player, can be configured to receive and play an audio file. The audio file can comprise, for example, a music file that contains digital information to play a song. The playback device can also comprise a display screen that can display information about the song that is being received and/or played.

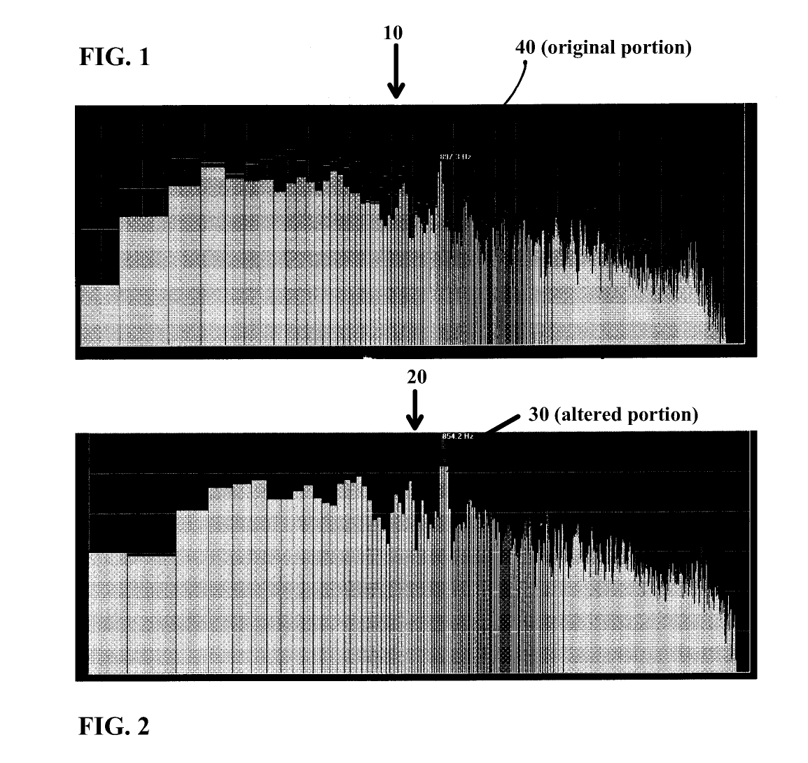

During playback, the system can manipulate the sound heard by the user at a predetermined point in the song or at a predetermined time, in a manner sufficient to gain the user's attention. For example, as shown in FIG. 1, an audio signal 10 can comprise a plurality of audible frequencies that vary over time. Audio signal 10 can comprise, for example, a portion of a song. By manipulating one or more portions of the audio signal 10, a second audio signal 20 can be created. The second audio signal 20 can comprise an altered portion 30, in which the altered portion is different from the original portion 40. The altered portion 30 is preferably different enough from the original portion 40, so that the playback of the altered portion 30 is readily distinguished from the original portion. Thus, upon playback of the audio signal 20 (which comprises altered portion 30), the user of the playback device (e.g., the listener) will be aware of the playback of the altered portion 30.

The method of altering the original portion 40 to create a second audio signal 20 can be achieved in a variety of manners. For example, playback device can be configured to alter the first audio signal to create a unique, distinguishable portion of the song being played by the device. The location and/or timing of the distinguishable portion can be selected by the playback device and/or it can be predetermined (e.g., periodic or time-based). Alternatively, the original audio signal can be modified prior to delivery to the device. Thus, the playback of the altered portion can be predetermined by a device other than the playback device.

The type of alteration of the original audio signal can also vary. For example, the audio signal can have a different and/or unique tone inserted into the audio playback. Methods for creating tones such as these are described in more detail below. Alternatively, a portion of the original signal can be repeated, effectively causing the playback to “stutter” or “skip.”

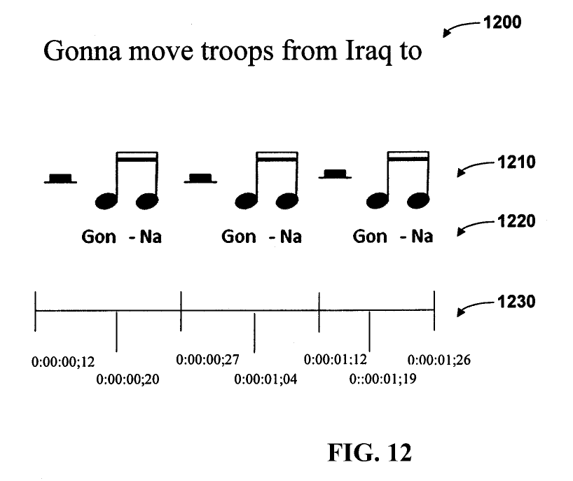

For example, FIG. 12 illustrates how existing dialogue in an audio or video presentation (e.g., a newscast) can be transformed into a rhythmic cadence along a time coded timeline. The original dialogue 1210 of the spoken words “Gonna move troops from Iraq to” occurs over approximately one second and 15 frames, or around one point five seconds. When a listener hears this plain text spoken, it is stored in a different area of the brain's memory than where music and rhythms are stored.

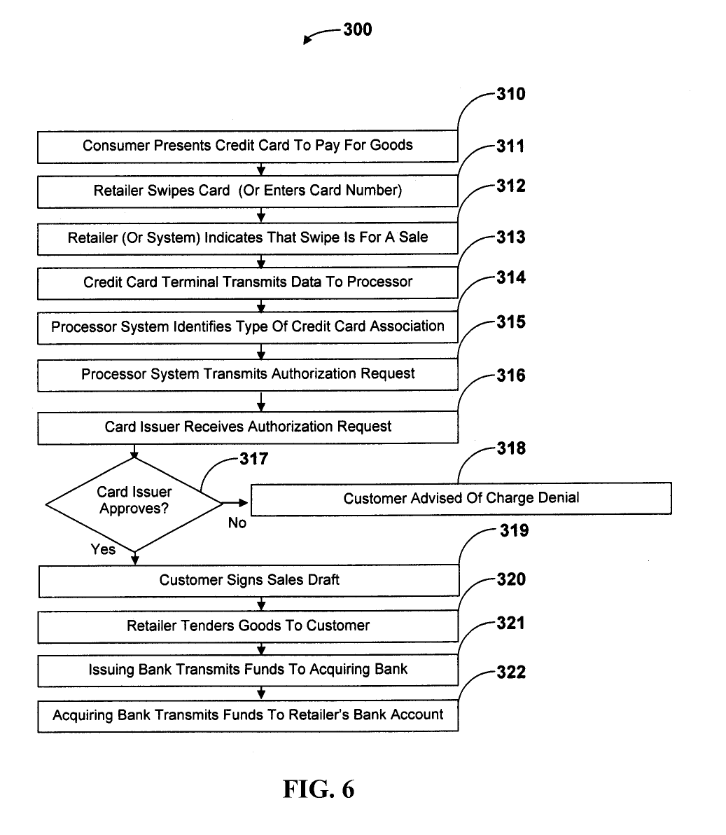

By manipulating the audio portion (and/or video portion) of the video containing the original dialogue 1210, one or more syllables can be transformed into a short, rhythmic pattern 1220. For example, by varying the length and accentuation of the first syllables in this particular example, the word “Gonna” can become rhythmic (i.e., musical) for the one second (or 15 frame) period of time according to the pattern displayed by the notes in 1220 and as depicted across time-coded timeline 1230 in FIG. 6.

When a user hears such a rhythmic pattern, they immediately recognize it as something different, which alerts the visual and audio senses. This heightened sense of awareness increase the value of the content, because the user is more engaged, and also increases the value of visual ads, such as banners or buttons, surrounding or otherwise delivered as part of the video or web based playback device.

The existing advertisements displayed immediately before, during or after the effect is applied can be adjusted in color, or have the destination URL changed dynamically, to reinforce that a special promotional opportunity exists for viewers that recognize the effect as indicating a reward opportunity.

A rhythmic variation, as described above, can be attributed to a portion of a conventional audio file (containing, for example, spoken words) by varying rhythm, stresses, or pitch of the original audio file. The rhythmic variations can be created by any of various methods, including, for example, by repeated playback of a portion of the file (repetitive rhythm) or otherwise adding additional sounds and/or causing them to be repeated and/or stressed to create a rhythmic portion.

Video Playback Manipulation

In another embodiment, a system for manipulating a video playback of an existing video file is provided. The video playback device, such as a video player configured to receive and play a video file, comprises a display screen to display the video that is being played. The video file also preferably includes an audio portion.

During playback, the system is configured to manipulate a portion of the video in a manner sufficient to gain the user's attention. For example, an audio portion of the video can be manipulated as shown in FIG. 1. Alternatively, an audio and video portion of the video file can be manipulated at the same time. For example, as discussed above with an audio signal only, a portion of the original video signal can be repeated, effectively causing the video playback to “stutter” or “skip.” Thus, for example, if the video file comprises a news story, during one manipulated playback, the news announcer could be seen to stutter as a portion of the video playback is repeated (e.g., by instructing the video player to play a short portion of the video, rewind the same portion, play the same portion again, rewind the same portion again, and play the same portion again).

Just as with the audio signal only embodiment, a video signal can be altered in a variety of ways. For example, video playback device can be configured to alter the video signal to create a unique, distinguishable portion of the video being displayed by the device. The location and/or timing of the distinguishable portion can be selected by the playback device and/or it can be predetermined (e.g., periodic or time-based). Alternatively, the original video signal can be modified prior to delivery to the device. Thus, the modification of the original signal can be predetermined by a device other than the video playback device.

Pre-Selecting Tones or Other Sounds for Use with an Audio and/or Video Playback Device.

In addition to inserting sounds into spoken word audio files, audio files that contain music or other rhythmic sounds can also be modified using the system. As noted above, the modification to the audio and/or video files can comprise the insertion of a tone to the files during playback. The tones that can be inserted can vary. For example, such tones can include abstract representations of notes to be played using various instruments or pre-recorded samples.

When modifying audio files that already contain rhythmic portions (e.g., such as music files), such tones are preferably selected so that they are relevant or related to the audio or video file being played by the user. For example, if the user is listening to rock music, the tone can comprise one or more notes played using a guitar for classic rock music. Alternatively, if the user is listening to hip-hop, for example, the tone can comprise one or more beats played on a drum machine. Thus, the inserted tone can be selected so that it matches the media being played. Although, it can be desirable to “match” the tone to the media, it should be understood that the insertion of the tone is intended to obtain the attention of the listener (user), thus, the tone should also be sufficiently distinct from the original media content (or at least sufficiently distinct from the adjacent media content between which the tone is inserted.

The tone can be previously inserted or the system can make a determination as to when the tone should be inserted into the audio or video signal. For example, in one embodiment, during the playback of an audio signal, the system determines if it is a proper time to deliver a distinct series of tones that will match the music that they are playing. If it is, then it delivers the tone.

Preferably, a user can set a number of preferences designating whether he or she would like to receive inserted tones and/or designating the type of inserted tones that can be used. The user can also configure options relating to tone expression such as volume, duration, delay, etc. Operators may devise formulas that govern the degree of customizability and provide for certain min and max thresholds.

In a preferred embodiment, the tone or modification to the music can be customized with music created by another artist or by the same artist. That is, the system can automatically mix another portion of an audio signal into the music so that it is synchronized and it doesn't take away from the listening experience. Preferably, the volume of the tone or signal is auto-leveled, synchronized and/or calibrated to match the music volume being played.

Customization or selection of the specific instrument to be used can depend on any environmental factor as discussed above. Additional (but not all inclusive) variables include specific instruments, pitches, notes, images, videos, subtitle text, track, album, artist, and band name, other meta information, and customizations that either the server or client have select. For instance, the tone can be representative of a tone of a particular company or business (e.g., a tone for a soft drink company). This can be helpful when associating the modified portion with an advertisement or other opportunity (as discussed in more detail below) that is connected to a company or business.

Additional environmental factors may include any available “sensory data” represented in virtual environments the user may be experiencing the music in, such as virtual worlds including, but not limited to Second Life, or multiplayer video games such as World of Warcraft or The Sims Online. A specific example is when a game would normally provide a sound based on an action of the user (e.g., kill a monster, get a power-up, pick up an item, gain a level). The system of the present disclosure can replaces the in-game sound with a different tone or with a modified version of the original tone.

Social networking information, and associated profile and relationship information may also be used for additional customization. An example of this would be tone modification or selection based on various data attributes found in a user's friends' profiles on social networking web sites including, but not limited to, Facebook, MySpace, Friendster, Bebo, and Orkut.

In a preferred embodiment, a user can create their own personalized tones for use by the system. The tone can be created by creating any short audio file. For example, the tone can be created by capturing a portion of an audio file. In another example, the tone can be created using any known device, such as a recording device or a sound-effects processor.

Association of Delivery/Playing of an Altered Portion of an Audio or Video File with a Request or Opportunity for the Video or Audio User to Perform an Action.

The delivery or playback of a modified audio or video signals preferably relate to a request for user interaction. For example, when a tone is heard during playback, an optional action can be requested of the user (client). This action may include, but is not limited to answering a brief survey, downloading a file, or opening up another URL or media file/asset. All of the same environmental factors that influence tone generation may also influence action ‘generation’ and/or ‘requirement-to-act.’ Additionally, information about tones already played and actions already taken may also be taken into account.

The user can ignore the request. Based on settings, configuration options, and/or preferences, the request can come back at another interval. Alternatively, the request can be stored for later access by the user. For example, in one embodiment, a tone can be associated with an opportunity provided to the user. If declined or ignored, the request can be stored at a known location so that the user can access the opportunity at a later time.

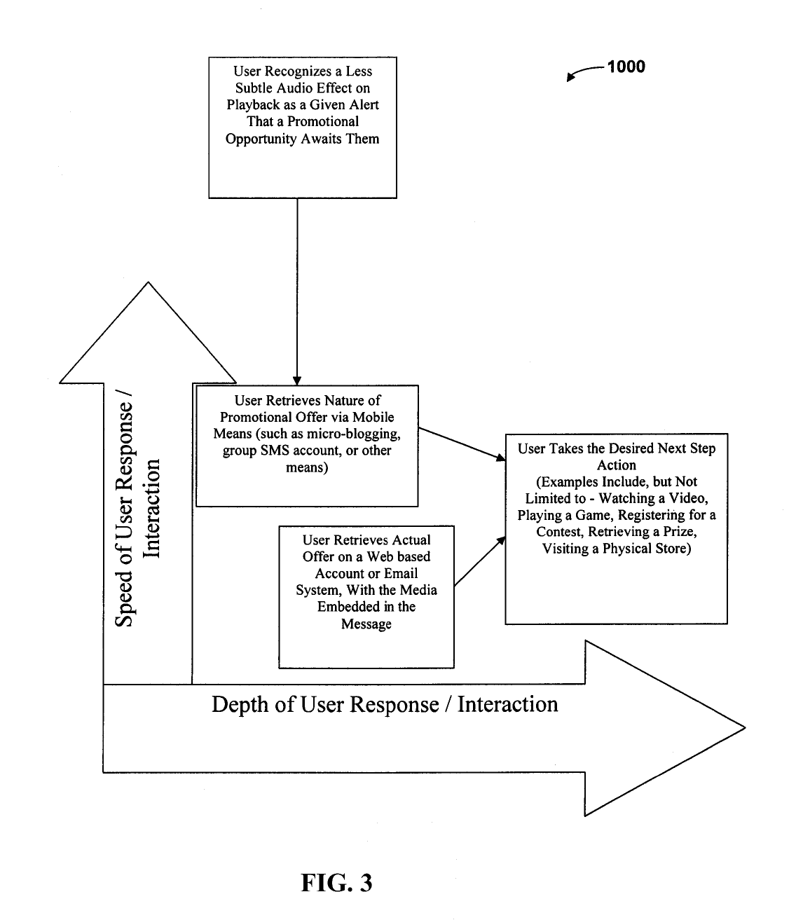

FIG. 3 is a flow chart that describes an embodiment 1000 where a user is provided with an audio or video signal that is interrupted or modified with an audio effect on playback. The audio effect acts as an alert to let the user know that a promotional opportunity is available to the user. The user can display the promotional opportunity on the display of the playback device. To display the promotional opportunity, it can either be delivered directly to the playback device or the user can request receipt of the promotional opportunity, which is then downloaded or otherwise retrieved by the device.

After receiving the opportunity (e.g., promotional offer) the user can take the desired next step or action provided by the opportunity. This next step, for example, can comprise watching a video, playing a game, registering for a contact, retrieving a prize, and/or visiting a physical store.

Delivery of Music and Other Media Associated with Various Opportunities/Requests.

The media industry has suffered recently because fewer and fewer people are purchasing music and videos. Instead, streaming songs or video on demand or through the internet has replaced the practice of purchasing media. Similarly, when people consume video online or through other on-demand methods currently emerging, they rarely want to wait for a video ad that plays prior to their consumption or play during their consumption, disrupting the experience. Many users will simply leave and go to a competing site, hurting an advertiser's or media company's ability to hold the user's attention. If an ad plays afterwards, many users will opt to leave the site before the ad is finished.

Record labels, artists and trade associations ultimately suffer from these new forms of consumption since advertisers are rarely willing to pay for the revenue needed to support these sites because users are not looking at the visual ads displayed, but are instead listening to the audio stream and doing other things. Similarly, if a traditional audio ad interrupts a listening experience, the user may feel irritated and may not return to listen again until the provider stops playing the traditional audio ads.

So-called “free” music and video sites exist; however, they usually come packaged with advertising interruptions that many users find irritating, such as pop-up ads and video pre-roll ads. As a result, there is a need for a system that provides for the transporting, sharing, and delivering of music and other video media in a manner that is non-obtrusive for consumers.

The present disclosure describes mechanisms for achieving this goal. The systems described herein can actually enhance the listening experience of a user by making them listen intently for sounds or modifications to the original signal. In addition, a user can be provided with an opportunity to take action and receive something of value as a result.

The valuable item can be, for example, access to additional music or video. That is, by engaging or initiating with the request for action and/or the opportunity provided to the user, the user can gain additional rights to listen to more music.

While the user is obtaining additional rights to music, the owner of the rights in the altered music or video signal can also be compensated. That is, the value of rights received by the user, or a portion of the value received by the user, can be specifically assigned to the owner of the content. In this manner, the user doesn't have to purchase anything in order to continue using the media, the cost of the use of the content (or a portion of the cost of the use of the content) can be provided to the owner by the sponsor.

Thus, the system can allow for the granting of specific permissions or rights to further use, license, and/or experience the media when the requested action is taken. The system tracks these rights and correlates them to the specific action and tones that caused them to be granted. In one embodiment, users can earn points for listening to music, listening to tones, and performing various actions. These points can be used to acquire more listening or viewing rights, change tone configurations etc.

These points and/or song rights information can be stored in a central database. Thus, for example, if a user plays a particular song, the system will check to see if the user has rights in the song or is otherwise entitled to play the song. The database (or other tracking functionality) can keep track of how many songs a user can play, while logging the songs the user has played using, for example, a structured data interchange format or other means known in the art.

In another embodiment, the points earned by a user for taking advantage of a request or opportunity can accumulate as credits in the system. These credits can be collected by the user and either used to obtain items of value (e.g., redeemable for coupons, rewards, or other savings at a business), or they can be accumulated to increase intangible reputation within an online community.

As discussed in more detail herein, the interactions are preferably non-obtrusive and timed or otherwise connected to the music. The system can permit monetary proceeds to be allocated to the parties that have rights automatically. Therefore, the delivery and allocation of the proceeds can be performed by a clearing house, instead of needing to be accomplished at the level of the distribution service. Since it is done at a clearing house it means anyone that has any distribution methodology can take part in it because they just tie it into their system.

Selection of Timing of Modifications to Media.

As noted above, the timing of the modifications to the original media content can be performed by the playback device or the timing can be predetermined prior to receipt of the audio. Thus, the system has the ability to insert tones or otherwise modify the original signal at intervals controlled by the operator. Dynamic timings, such as those that use realtime feedback loops from client interaction and usage may also be employed. The timing of such modifications can also be controlled and configured by the system operator. These dynamic timings are not limited to customer interaction and may be influenced by any event notification receivable by the system. Examples include, but are not limited to events on a communications network such as via HTTP, HTTPS, RTSP, XMLRPC, SOAP, TCP, UDP, RSS, MediaRSS, OPML, and other protocols, financial optimization systems, and ratings systems such as Neilson or ComScore.

Use of Location Information to Target Modifications to Media.

The system may also use geolocation information, including but not limited to longitude, latitude, altitude, attitude, compass direction, and speed. Additional environmental awareness functionality includes, but is not limited to incorporating information related to number and proximity of devices near-by, and any information available on a mapping system such as Google maps or proprietary map databases.

Different points of interests (e.g., coffee shops, restaurants, bars, bookstores) can cause different tones to be generated in different ways. Multivariate analysis can be performed such that any or all pieces of available data are combined into a profile that controls the precise nature of the tone and timings.

Tracking of Media Modifications.

The modifications to the media described herein can be tracked by the system using either active or passive mechanisms. For example, passive tracking can include the use of special tracking codes that layer 5 switches would be aware of for instance. Active tracking includes tracking how many media assets were embedded with a specific tone and when, who the assets were sent to, how long they experienced that asset (listened to, watched, interacted with, etc).

By tracking responses to opportunities of a particular user, the system can modify the tones and/or opportunities that the user responds best to. Thus, the type of tones used can be customized for each user, as well as the types of opportunities.

Determining Geographic Locations of Users and Delivery of Media in Response to the Same

In another embodiment, systems and methods for determining the location of a user are provided. In today's mobile society, the connection of people with people and people with businesses is becoming ever more complicated. In this embodiment, electronic payment mechanisms can be used to increase the ability to communicate the location of a user with other persons, businesses, or other geographically near opportunities.

Persons are increasing using electronic payment mechanisms, such as credit cards, debit cards, e-checks and ACH and other payment mechanisms instead of physical currency (cash) or paper checks as the primary means of purchasing. As these mechanisms evolve even further, it is likely that more and more in-person payments will be made using such electronic payment mechanisms. As described below, such electronic payment mechanisms can be used to locate individuals to provide them with geographically specific opportunities (such as discussed above), or to link them to other individuals or businesses in the community.

With regard to linking individuals in the community, various online communities can be used to facilitate such connections. For example, once individuals connect online, or list their interest, profiles or other attributes, content provider, online dating services, socialization destinations, advertisers and other parties generally gather this information in a database that can be used to increase the chances that a user will be able to connect electronically (via the Internet, instant messaging or SMS or other means) with others they have an interest in meeting or potentially getting to know. However, these methods still require that individuals go through many of the same channels, such as describing what they are wearing, picking a meeting place, coordinating and, planning ahead before they can physically interact with parties that share their interest or otherwise have characteristics giving rise to the desire to meet in person.

Since electronic payment methods require a unique merchant identification method, such as a merchant ID, and each such ID corresponds to a given location at the time of a transaction, what is needed is a novel system, method and apparatus that enables permission based notification of a consumer's location to a socialization, dating or other database. This would permit the convergence of the trends mentioned above, and give rise to the ability to announce, via mobile computing devices, the Internet, SMS, instant messaging and other communication mechanisms, when parties of common interest are in a similar region or indeed in the same location.

Similarly, with knowledge of the user's location, concert promoters can target users that were close to a given venue where a certain artist was performing. For example, extra tickets can be given away as a promotion to users that have responded in the past to a micro audio or sound effect alert in accordance with the embodiments disclosed herein. This can cause a cascade of commerce, from the credit card issuer, the merchant, the concert promoter, the artist, the publisher/media company that originally served the audio effect and so forth.

Some of the disclosed embodiments herein relate to technology for using merchant payment transaction data in real time to log the location of a consumer, populate a database with that location, within a given time period, and thereby allowing parties with common interest or existing relationships the option to interact, via instant messaging, Short Message Service, SMS, or other communications modalities that can be used in conjunction with very small snippets of sound added to tracks, or alternatively, modifications of a sound signal, such as a sound effect. These effects and sounds, very brief in duration, make a user aware of a promotional opportunity they may have an interest in, causing them to take some action or to look at the player they are using to consume audio content or click on a link associated with a piece of video content.

In view the challenges and problems with the prior art described above, the disclosed embodiments provide a method, system, apparatus, software to enable the mutual benefits that would accrue to both merchants, socialization and dating site operators, marketers and innovators and the increasing worldwide population of website users and electronic payment users, to be realized by capturing consumer location information, approved for broadcast by consumer and other parties such as the site operators, payment processors and card or payment mechanism issuers, to facilitate meeting in person in real time parties of interest to the consumer using SMS or other communication modalities.

Moreover, the disclosed embodiments provide a way to get the attention of people when they are listening to audio or viewing video being streamed or otherwise delivered, without interrupting their primary consumption, as would be the case with the prior art methods such as audio or video ads immediately before or immediately after their consumption.

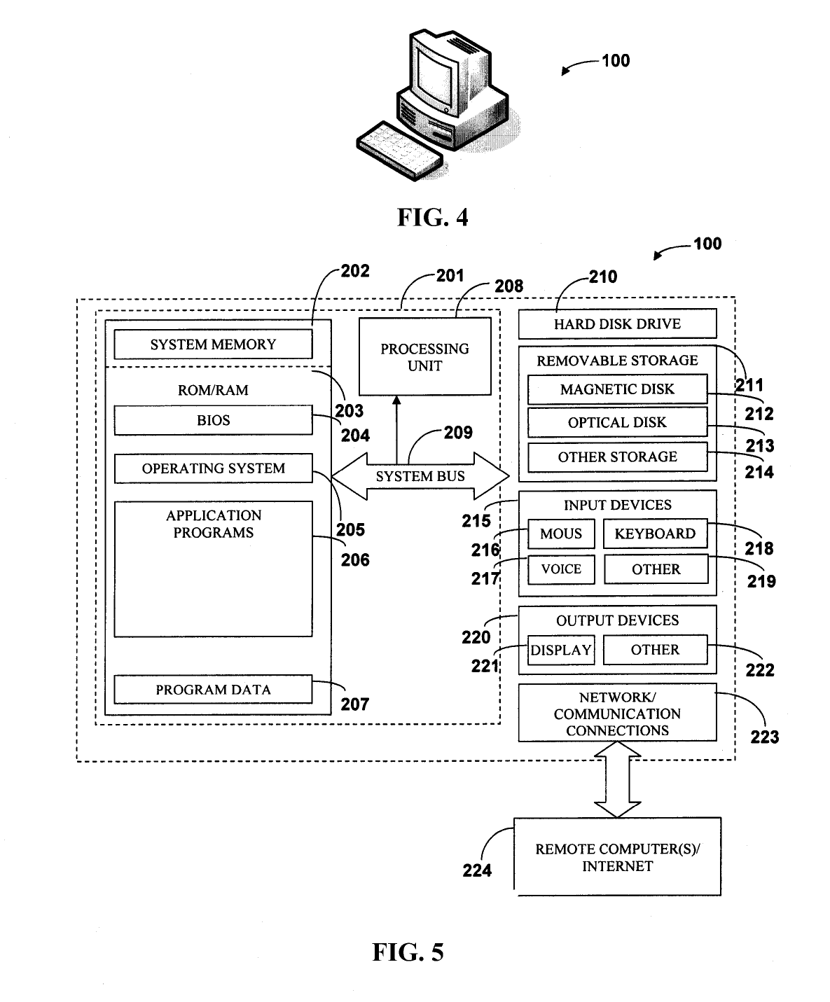

FIG. 4 illustrates an exemplary computer system 100 that can be used to execute the software of an embodiment of the disclosure. FIG. 5 illustrates a block diagram of the exemplary computer system 100 shown in FIG. 4, including; output devices 221 such as, but not limited to, a display 222, and other output devices 223; input devices 216 such as, but not limited to, a mouse 217, a voice input device 218, a keyboard 219 and other input devices 220; removable storage 211 that may be used to store and retrieve software programs incorporating code that aids or executes the various systems or stores data for use with those systems, or otherwise interacts with those systems, such as, but not limited to, magnetic disk storage 212, optical storage 213 and other storage 214 that a hard drive 210 that may be used to store and retrieve software programs incorporating code that aids or executes the systems or stores data for use with the systems, or otherwise interacts with the systems; and typical system components, such as those within dashed line 201, including but not limited to system memory 202, which typically contains BIOS (Basic Input Output System) 204, RAM (Random Access Memory) and ROM (Read Only Memory) 203, an operating system 205, application programs 206, program data 207, a processing unit 208, system bus 209, and network and or communications connections 224 to remote computers and or the Internet 225.

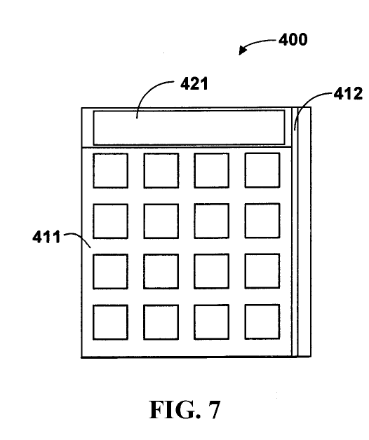

FIG. 6 is a flow chart of a conventional method and apparatus for processing a physical (swiped, keyed or transmitted) electronic payment transaction for a single retailer. The conventional method 300, typically involves a consumer 310 presenting their card to the retailer who swipes or enters 311 the card number. The retailer either indicates or the system otherwise determines 312 that the swipe is for a sale transaction 313. The credit card terminal transmits the card and transaction data to the processor 314, such processor who will automatically determine the type of credit card association 315 and transmit the authorization request to the proper card issuer. The card issuer will receive the authorization request from the processor 316 and either approve or deny 317 the request for authorization. If the request is not approved, the retailer will advise the customer of the denial 318. If the request is approved, the retailer will typically have the customer sign a sales draft 319 and then tender the goods purchased to the consumer 320, or allow the consumer to order drinks or other items on a tab as a result of the approval and then enter an amount upon settlement. Following approval, the retailer will use any one of a number of well known routines within the art to capture the transaction and request settlement. The issuing bank will transmit funds to the acquiring bank 321 and the acquiring bank (sometimes through another processor) will transmit funds to the retailer's bank account 322. As illustrated, the conventional method does not contemplate transmitting location information, using merchant's ID, to a socialization website, dating website or other database to allow the consumer to connect with new or existing friends and associates, for instance. Similarly, such prior art system does not contemplate that controls can be turned on and off, giving permissions to a database, through either the card issuer, the processing company's database, or other members of the payment chain, in automated electronic coordination with the socialization, dating or other site, to use the location information and broadcast it to other users based on the consumer's criterion and rules. Moreover, all of this functionality can be electronically implemented with existing credit card terminals, POS or other computing device similar to that shown in FIG. 7.

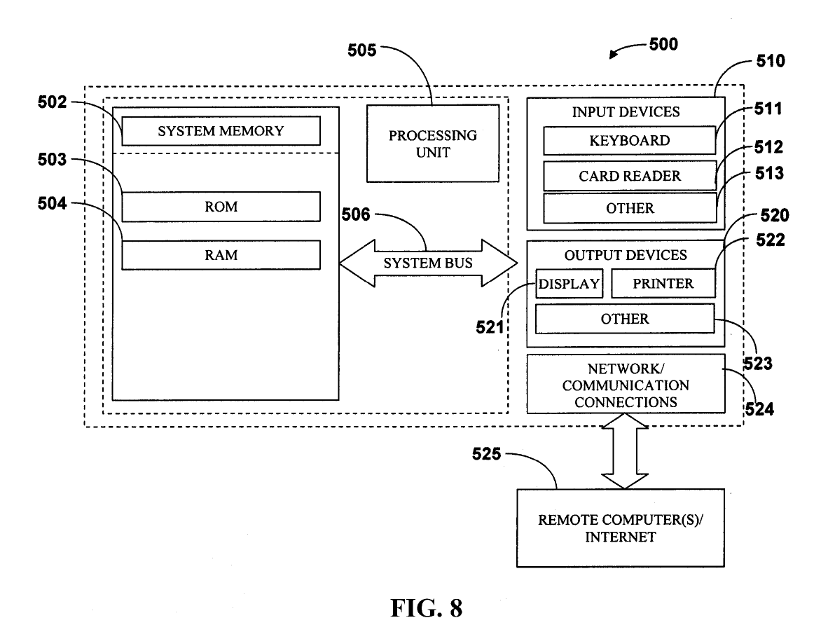

FIG. 7 illustrates an exemplary POS transaction entry terminal that may be used to execute the software of an embodiment of the present disclosure, such as POS transaction entry terminal 500. In a very basic configuration, POS transaction entry terminal 500 typically includes a display 521, a credit (or debit) card reader 512 and a keyboard 511. Additional items typically found in POS transaction terminal 500 included those noted in FIG. 8.

FIG. 8 is a block diagram of the exemplary POS transaction entry terminal system shown in FIG. 4. including; output devices 520, such as, but not limited to, a display 521, a printer 522, and other output devices 523; input devices 510 such as, but not limited to, a keyboard 511, a card reader 512 and other input devices 513; and typical system components, such as those within dashed line 501, including a variety of storage and memory devices that may be used to store and retrieve software programs incorporating code that aids or executes the system or stores data for use with the system, or otherwise interacts with the system, such as, but not limited to, 503 RAM (Random Access Memory) and 504 ROM (Read Only Memory), 502 system memory; a processing unit 505 and possibly a system bus 506; and network and or communications connections 524 to remote computers and or the Internet 525.

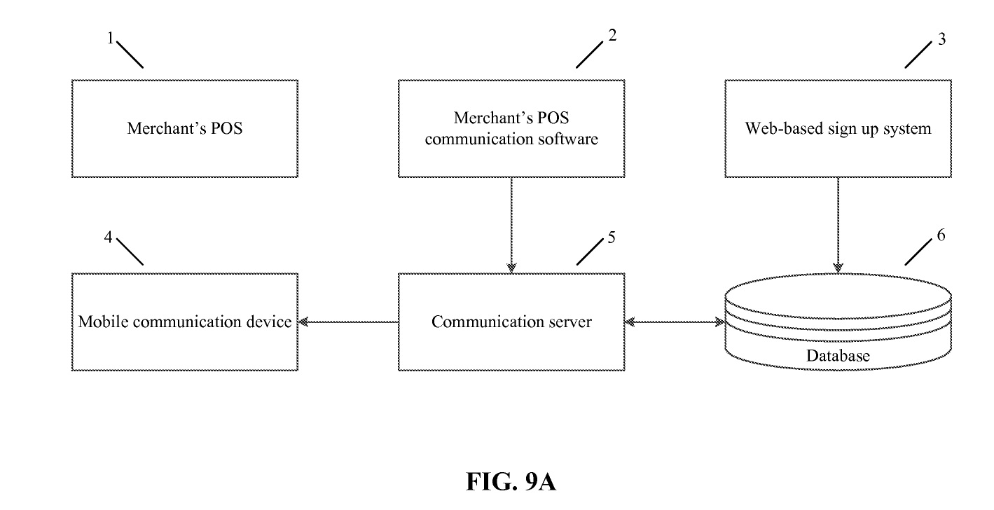

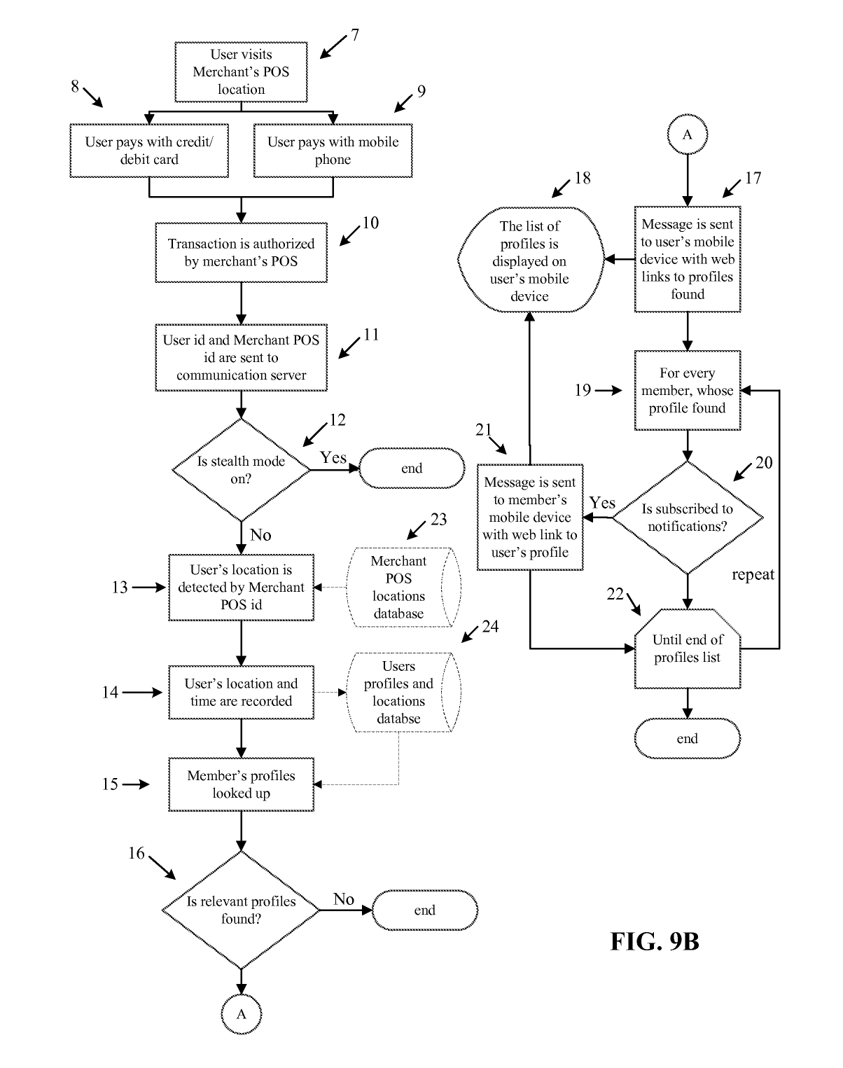

FIG. 9a is a flow chart of a system architecture in accordance with one embodiment of the present disclosure, including:

1—Merchant point of sale—the workplace at merchant's business location (such as restaurant, bar, café, shop, laundry etc), equipped to accept electronic payments such as credit/debit cards or instant mobile phone payments;

2—The communication software or module installed at Merchant's POS 1, which allows the communication of certain information about transactions to a communication server;

3—Web-based sign up system allowing members to register and complete their profiles/preferences;

4—Member's mobile communication device such as mobile phone or smartphone;

5—Communication server 5, which enables location-based communication between members; and

6—Database, storing users and merchants profiles and location information.

FIG. 9b is a flow chart illustrating using the processing a credit card transaction to populate a database with a consumer's location and trigger socialization and dating possibilities in accordance with one embodiment. As illustrated in FIG. 9b, a consumer 7 who is system member, visits member merchant's POS location 1 carrying his mobile device 4 with him/her 8 pays with credit or debit card 9, or under yet another embodiment 9, pays with their mobile phone. Continuing with FIG. 9b, the transaction 10 is authorized by merchant's POS 11; however, additionally user's id and merchant id are sent to the communication server 5 by Merchant's POS communication software 2 for validation. The user's id can be sent in impersonalized form—for the case of credit/debit card payment the irreversible hash (for example, md5) of user's full name and last four digits of the card is submitted, for the case of mobile phone payment the irreversible hash (for example md5) of user's mobile phone number is submitted. Next, in 12, Communication server 5 checks if user has stealth mode on. If yes then the process ends. In 13, communication server 5 detects user's location based on merchant POS id and merchants POS locations stored in the database 23. That provides the address and geographical coordinates of current user's location.

In step 14, user's location detected in 13 is recorded in the database along with current time-stamp 15 and communication server 5 then looks up in members' location database profiles of members, based on several criteria: member's current location should be close to current user's location, member's profile should meet criteria specified in user's profile during sign up 3. Search criteria are configurable by user and may include advanced location-based criteria like “member should prefer the same dinning places as myself.” Next, in step 16, communication server 5 can detect if any relevant profiles were found by look up 15 and, if so, can arrange them by relevance. If no relevant profiles are found then the process can end. If relevant profiles are found, then the system proceeds to step 17. In step 17, a message is sent to user's mobile device 4, containing short summary for every profile found and link to the complete member profile on the web. The message can be sent as SMS or Email or other format depending on user's mobile device capabilities.

Then, in step 18, the message sent in step 17 can be presented on the screen of a user's mobile device 4. The user can view member's profiles and decide to initiate communication with some of members in any standard way. In step 19, communication server 5 can cycle through the list of members found by look up 15. In step 20, for every member his profile is checked to see if the member is subscribed to other peoples' notifications. If yes, then the member can be notified 21. If not, the process can end.

In step 21 of FIG. 9b, a message similar to 17 with user's short summary and profile web link can be sent to the member's mobile device. The message can be sent as SMS or email or other format depending on the member's mobile device capabilities and/or designations. In step 22, steps 19 to 21 can be repeated until the list of members profiles found by look up 15 is exhausted.

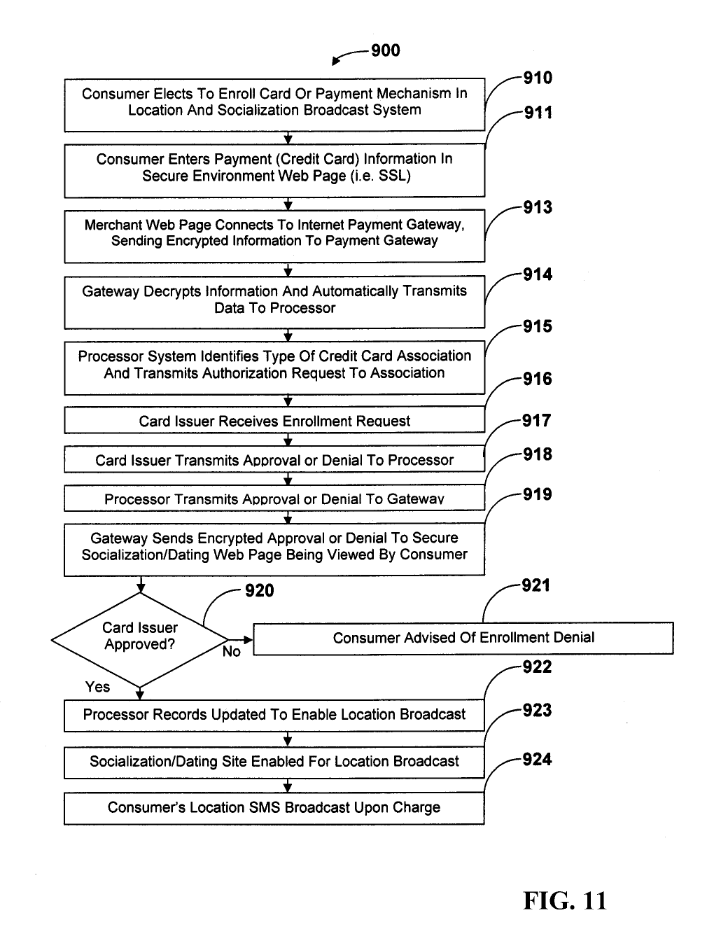

FIG. 11 is a flow chart of a process flow for enrolling consumers and their cards for association with location based socialization sites in accordance with an embodiment. As illustrated in process 900, a consumer 910 can elect to enroll a credit card or other electronic payment method into location based socialization broadcast system. In step 911, the consumer can enter their payment information (e.g., credit card) in a secure connection, such as secure socket layer web page 913. The merchant secure web page 913, which could be for instance the page of a dating site, discussion forum or even the page of a bar or restaurant itself where a consumer might use the card to start a bar tab, connects to an Internet payment gateway, sending encrypted information to the payment gateway.

Next, in step 914, the payment gateway can decrypt the information and automatically transmit it to a processor. However, instead of (or in addition to) transmitting the information to make a payment or be approved for a future payment, the information can be sent to the processor in 910 to 913, and after becoming enrolled, to broadcast location information to the dating or socialization site the consumer is trying to enroll in.

Next, in step 915, the type of credit card is identified and the authorization request is transmitted to the appropriate association. However, this information again can be related to gaining approval to be enrolled in, and have released via SMS or other broadcast, the consumer's location using credit card and merchant information. In step 916 the card issuer can receive the enrollment request and in step 917 it can transmit an approval or a denial of the request back to the processor. Next the processor transmits the approval or denial to the gateway, and in step 918, the gateway can send an encrypted approval or denial to the secure site in step 919 in which the user is trying to enroll. If the enrollment is approved in step 920, then the processor records can be updated in step 922. The socialization, dating or other site can then be enabled to broadcast user location information upon charges in step 923, and the users location can be sent via SMS or other communication means 924. Otherwise, if the charge is denied in step 920, then the consumer can be advised of denial of enrollment in step 921.

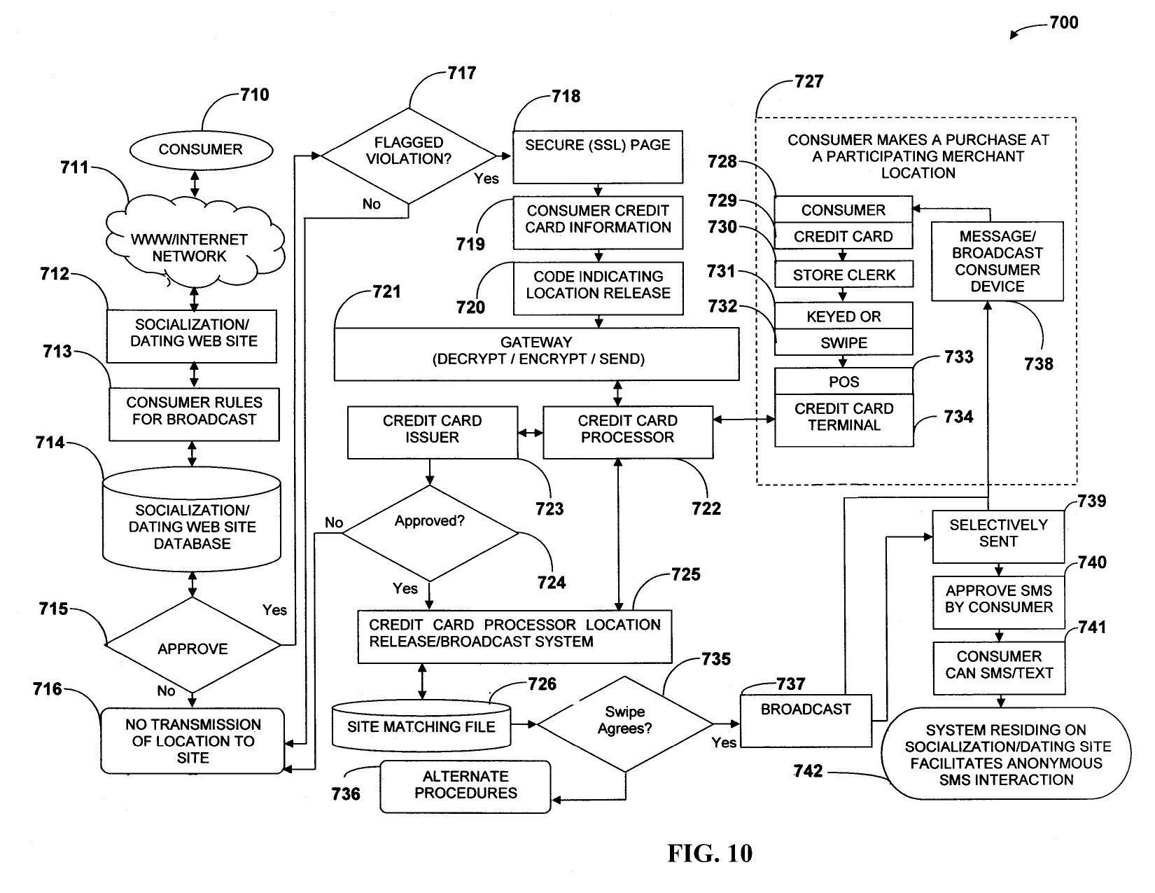

FIG. 10 is a flow chart illustrating yet another embodiment, showing a process from start to finish through which a consumer can register to provide his or her location to one or more of various social network or other groups. Consumer 710 can initially go to a socialization or dating type website 712, via the Internet 711, utilizing a computing device connecting to the Internet 711, such as the computing device shown in FIG. 4 and FIG. 5, and selecting rules for broadcast of their location via SMS 713. The system can compare the rules entered by the user to the socialization, dating or other similar site database 714 for an initial approval 715. If initially not approved in step 715, then in step 716, no transmission or receipt of location based information is provide and/or received for that consumer. If they are initially approved in step 715, then a second test can be run, for instance against multiple databases to see if the consumer 710 was previously flagged for electronic payment based location SMS broadcast violations 717. If they have been flagged for violations, then in step 716, no transmission or receipt of location based information for other users or that consumer. If the consumer 710 has not been flagged for violations, then they can be routed to the secure page to attempt enrollment of a specific credit card 718.

Consumers 710 can enter their consumer credit card information in step 719 and a special code 720 can automatically accompany the transmission indicating that the transmittal is for location based information release enrollment. As illustrated in FIG. 10, after the consumer instructs the secure page to do so, typically by clicking a submit button or series of buttons, the merchant web page can connect to an Internet Payment Gateway (or “Gateway”) and send encrypted information regarding the transaction and payment card to the Gateway 721. This procedure can be similar to that of a conventional method except that in addition to the Secure Payment (SSL) page 718 in FIG. 10 transmitting, in encrypted form, the consumer credit card information 719, the Secure Payment (SSL) page 718 also transmits, in encrypted form, a code indicating that a request for enrollment in location based broadcast upon charges 720, enabling other site members to see the consumer's location, via SMS or other communication modality, upon consumer 710 making a charge or electronic payment at a given merchant 727's physical location. This information is sent via Gateway 721, which decrypts, encrypts and sends in accordance with prior art methods used in credit card processing.

As in conventional systems, the credit card processor 722, in FIG. 10, can automatically rout the consumer credit card information 719 to the appropriate card association and or issuer 723 for approval. However, unlike a conventional method, the approval is not for payment but for enrollment in location based SMS broadcast to a dating, socialization or other site members in accordance with rules, upon a future electronic payment transaction at a physical merchant location 727. If the enrollment is not approved 724 by the credit card issuer 723, the consumer 710 and the system 700 then no transmission of the consumer's location, and therefore no receipt of the location of other via SMS, to the site will occur 716. Also, unlike the prior art, if the transaction is approved by the credit card issuer 723, the credit card processor 722, in FIG. 10, has been instructed by the code in 720 to route certain data regarding the location of the consumer 710, upon a future transaction, at a participating merchant 727 via the 725 credit card transaction location release and broadcast systems, and a matching database 726, also configured in accordance with the disclosed systems, that will be used to identify and retrieve consumer information to prevent identify theft or piracy, before to broadcasting the location of consumer 710 at merchant 727 and verify that the credit card 730 matches consumer 710 when presented by the consumer 728 in person.

Upon receiving an approval of enrollment 724, in FIG. 10, the consumer can be notified, but unlike a conventional credit card transaction the approval is for enrollment, not payment, and the processor systems 725 and 726 and site 712 and site database 714 are also made aware of the enrollment, allowing them to coordinate, electronically, and release information related to the location of the consumer 710 to participants of interest to the consumer, when a charge is run at merchant 727 by consumer 710.

As illustrated in FIG. 10, when the consumer 728 arrives at the participating merchant's physical location 727, and runs a charge, the store clerk 731 or other store personnel, can alternatively enter a key code 731 into their POS 733 and or credit card terminal 734. This key code will allow the their POS 733 and or credit card terminal 734 to recognize the upcoming credit card swipe 732 as a swipe to be matched with a database for approval of SMS broadcast, and also potentially allow ala carte participation and billing of the merchant, of that was previously entered into by the consumer 728 cardholder at the Socialization, Dating or similar Web Page 712, and that the swipe 732 is solely to enroll the consumer 710 and verify and validate the coordinated approvals of card-holder/consumer 710, card issuer 723 and processor 722, in agreement with card presented as being identical. After swiping the card, the POS 733 and or credit card terminal 734 transmit the card information to the credit card processor 722, which automatically routes the information to the location release/broadcast system 725, and a matching database 726 to verify the approvals for broadcast of location upon charge at merchant 727 and verify that the credit card 730 matches when presented by the consumer 728 in person.

The location release/broadcast system 725 and a matching database 726 can first compare the card information from the credit card 730 swiped 732 at the participating merchant's physical location 727 to the credit card information saved for matching in the matching file 726. If the information matches 735, along with approvals for enrollment, the system will then initiate the two way broadcast of parties at that location 737 using the matching database 726 and rules in 713, enabling approval of SMS's sent to the consumer via 740, selectively 739, and allowing the consumer 741 to communicate and interact with other members of the collective.

If, as illustrated in FIG. 10, the location based release/broadcast system 725 and a site matching database 726 compares the card information from the credit card 730 swiped 732 at the participating merchant location 727 to the credit card information saved for matching in the matching file and the broadcast rules 726 and the information does not match 735, alternate procedures 736 can be undertaken to enable broadcasting on the next attempt, or on a future visit. Such alternate procedures can include calling the issuing bank or processor for phone based interviews and confirmations, as is done in the prior art, but with the sole purpose of verifying that the consumer 710 and credit card information 719 are authentically the same consumer 728 and credit card 730 enrolled in the system. If they are not, the processor can automatically inform the issuing bank and or association 723, thereby further preventing fraud, identity theft or privacy violations.

In view of the many possible embodiments to which the principles of the disclosed embodiments can be applied, it should be recognized that the illustrated embodiments are only preferred examples and should not be taken as limiting the scope of protection. Rather, the scope of the protection is defined by the following claims. We therefore claim all that comes within the scope and spirit of these claims.

We claim:

1. A method of alerting a user to an opportunity, the method comprising:
providing an audio output device with a display screen;
delivering an audio signal to the audio output device;
modifying at least a portion of the audio signal;
outputting the modified audio signal on the audio output device, the output of the audio signal being a plurality of sounds audible to the user; and
displaying the opportunity on the display screen at substantially the same time that the modified portion of the audio signal is output on the audio output device,
wherein the modified portion of the audio signal is altered from the original by an amount sufficient to alert the user to the promotional opportunity.

2. The method of claim 1, wherein the audio signal is modified prior to delivery to the audio output device.

3. The method of claim 1, wherein the audio signal is modified after delivery to the audio output device.

4. The method of claim 1, wherein the act of modifying the audio signal comprises inserting one or more tones into the audio signal.

5. The method of claim 4, wherein the inserted one or more tones comprise a sound preselected by the user.

6. The method of claim 1, wherein the act of modifying the audio signal comprises repeating the portion of the audio signal so that the user hears the same plurality of sounds repeated two or more times.

7. The method of claim 1, wherein the opportunity comprises a request for the user to perform an action.

8. The method of claim 7, wherein the action that is requested to be performed by the user is the completion of a survey.

9. The method of claim 7, wherein the action that is requested to be performed by the user is the downloading of a file.

10. The method of claim 7, wherein the action that is requested to be performed by the user is the opening up an URL or media file/asset.

11. A method of alerting a user to an opportunity, the method comprising:
providing an video output device with a display screen;
delivering a video signal to the video output device;
modifying at least a portion of the video signal;
outputting the modified video signal on the video output device, the output of the video signal including a plurality of images visible to the user; and
displaying the opportunity on the display screen at substantially the same time that the modified portion of the video signal is output on the video output device,
wherein the modified portion of the video signal is altered from the original by an amount sufficient to alert the user to the promotional opportunity.

12. The method of claim 11, wherein the modification to the video signal comprises modifying an audio component of the video signal.

13. A method of rhythmically varying an audio file:
providing an audio output device with a display screen;
delivering an audio signal to the audio output device;
modifying at least a portion of the audio signal so that upon playback, the modified portion comprises a rhythmic portion;
outputting the rhythmic portion, the rhythmic portion comprising a plurality of sounds audible to the user; and
displaying an opportunity on the display screen at substantially the same time that the rhythmic portion of the audio signal is output on the audio output device.

14. The method of claim 13, wherein the rhythmic portion is sufficiently different from adjacent portions of the audio file during playback to gain the attention of the user.

15. The method of claim 13, wherein the audio signal is modified prior to delivery to the audio output device.

16. The method of claim 13, wherein the audio signal is modified after delivery to the audio output device.

17. The method of claim 13, wherein the audio signal is part of a video signal and the video signal is also modified.
